(19) United States
(12) Patent Application Publication
(10) Pub. No.: US 2019/0130766 A1
(43) Pub. Date: May 2, 2019

(54) SYSTEM AND METHOD FOR A VIRTUAL VEHICLE SYSTEM

(71) Applicant: Honeywell International Inc., Morris Plains, NJ (US)

(72) Inventor: Lonny Wayne Rakes, Scottsdale, AZ (US)

(21) Appl. No.: 15/799,415

(22) Filed: Oct. 31, 2017

(51) Int. Cl. G08G 5/00; G08G 5/04; H04B 7/185

(52) U.S. Cl. CPC G08G 5/0004; G08G 5/045; G08G 5/0047; G08G 5/0039; H04L 67/12; G08G 5/0021; H04B 7/18578; G08G 5/0008; G08G 5/0013; G08G 5/0034

(57) ABSTRACT

A method is provided. The method comprises receiving, at an off-board computer that is remote from a vehicle, data from at least one sensor onboard the vehicle; determining, with the off-board computer in response to the received sensor data, information for aiding an operator of the vehicle in piloting the vehicle; and sending the determined information to a portable computer onboard the vehicle, the portable computer being separate from any on-platform computer installed in the vehicle and being configured to render the determined information for consumption by the operator.

### BACKGROUND

Modern airliners include sophisticated vehicle guidance systems to aid pilots control of the aircraft, to improve flight efficiency (such as decreased flight time or fuel consumption), and to improve flight safety. Owners of smaller aircraft, such as single engine propeller aircraft, cannot typically afford such equipment. Space and weight constraints also limit options for adding avionics equipment to smaller aircraft. However, it is desirable to provide the pilots of such smaller aircraft with the control, flight efficiency and safety benefits of such equipment. Therefore, there is a need to for a cost-effective means to provide benefits of such equipment in smaller aircraft.

### SUMMARY

A method is provided. The method comprises: receiving, at an off-board computer that is remote from a vehicle, data from at least one sensor onboard the vehicle; determining, with the off-board computer in response to the received sensor data, information for aiding an operator of the vehicle in piloting the vehicle; and sending the determined information to a portable computer onboard the vehicle, the portable computer being separate from any on-platform computer installed in the vehicle and being configured to render the determined information for consumption by the operator.

### DRAWINGS

Understanding that the drawings depict only exemplary embodiments and are not therefore to be considered limiting in scope, the exemplary embodiments will be described with additional specificity and detail through the use of the accompanying drawings, in which:

FIG. 1 illustrates a diagram of one embodiment of a virtual vehicle systems network;

FIG. 2 illustrates a block diagram of one embodiment of the first vehicle configured to display an output of a virtual vehicle system;

FIG. 3 illustrates a block diagram of one embodiment of an operations center;

FIG. 4 illustrates one embodiment of a method of operation of an operations center;

FIG. 5 illustrates an exemplary method of operation of a virtual vehicle system; and

FIG. 6 illustrates one embodiment of a rendered image on a display of a portable computer.

In accordance with common practice, the various described features are not drawn to scale but are drawn to emphasize specific features relevant to the exemplary embodiments. Reference characters denote like elements throughout figures and text.

### DETAILED DESCRIPTION

In the following detailed description, reference is made to the accompanying drawings that form a part hereof, and in which is shown by way of illustration specific illustrative embodiments. However, it is to be understood that other embodiments may be utilized and that structural, mechanical, and electrical changes may be made. Furthermore, the method presented in the drawing figures and the specification is not to be construed as limiting the order in which the individual steps may be performed. The following detailed description is, therefore, not to be taken in a limiting sense.

A virtual vehicle system may be used to overcome the above referenced problem. The embodiments of the virtual vehicle system have at least one advantage. A vehicle lacking physical vehicle equipment, but utilizing a virtual vehicle system can enjoy some or all of the control, safety and efficiency benefits of physical vehicle electronics systems used in more expensive vehicles. The virtual vehicle system is implemented with a portable computer is separate from any on-platform computer installed in the vehicle, but may be coupled to, the vehicle's electronics system. This permits the vehicle operator, e.g. pilot, to utilize inexpensive, non-certified portable computer executing software to provide the virtual vehicle system. Although the present invention is sometimes exemplified with aircraft, it is envisioned that it can be used in any other vehicle including without limitation an automobile, a truck, a bus, a train, a ship, and a spacecraft.

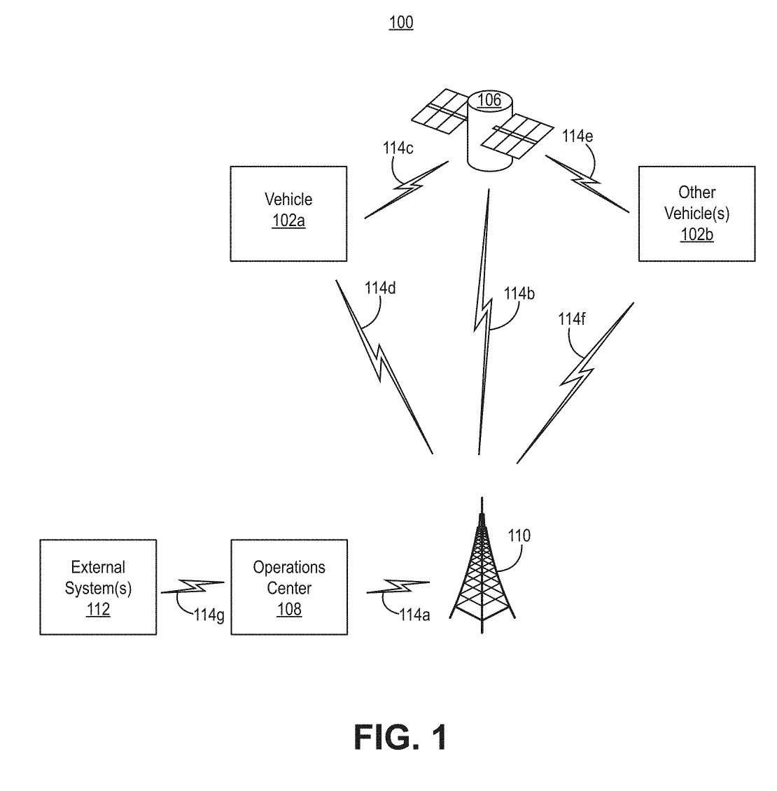

FIG. 1 illustrates a diagram of one embodiment of a virtual vehicle system network 100. In one embodiment, the virtual vehicle system network 100 comprises a first vehicle configured to display an output of a virtual vehicle system (vehicle or first vehicle) 102a, one or more other vehicles (other vehicle(s)) 102b, an operations center 108, a ground station 110, and a satellite 106. The operations center 108 is a facility—such as a server system or a cloud computing network—at which data collection and processing is performed. Although only one ground station 110 is illustrated for pedagogical purposes, more than one ground station may be coupled to the operations center 108, and used to implement the virtual vehicle system network 100.

Optionally, in one embodiment, the virtual vehicle system network 100 includes one or more external systems (external system(s)) 112. The external system(s) 112 are sources of data, e.g. about the first vehicle 102a and other vehicles. For example, the external system(s) 112 may include governmental and/or private sources of (a) flight plans such as US Federal Aviation Administration's (FAA's) system wide information management (SWIM) system, (b) the environment (e.g. the weather and/or geography) such as the US National Weather Service (NWS) and/or the US Geological Survey (USGS)).

In one embodiment, the operations center 108 and the ground station 110 are coupled by a first communications link 114a. In another embodiment, the ground station 110 is coupled to the first vehicle 102a through the satellite 106 through a second communications link 114b and a third communications link 114c. In a further embodiment, the ground station 110 is coupled to the first vehicle 102a through a fourth communications link 114d. In yet another embodiment, the ground station 110 is coupled to the other vehicle(s) 102b through the satellite 106 through the second communications link 114b and a fifth communications link 114e. In yet a further embodiment, the ground station 110 is coupled to the other vehicle(s) 102b through a sixth communications link 114f. The operations center 108 is coupled to the external system(s) 112 by a seventh communications link 114g. The first through seventh communications links 114a-g, as is appropriate, may each be one or more HF network(s), VHF radio network(s), SATCOM network(s), AeroMACS network(s), Wi-Fi network(s), WiMAX network(s), fiber optic network(s), cellular network(s), and/or any other type of communications network(s). In one embodiment, one or more of the communications links are encrypted to prevent tampering of data being transmitted and received, e.g. between the vehicles and the operations center 108 and/or between the operations center 108 and the external system(s) 112.

In one embodiment, the first vehicle 102a communicates data from sensors, or sensor data, to the operations center 108. For example, as will be subsequently illustrated, such sensor data is generated by sensors in or attached to a portable computer. In another embodiment, the operations center 108 receives information from other vehicle(s) 102b and/or external systems 112. In a further embodiment, other vehicle(s) 102b provide information about their location, travel route, location and/or travel route of proximate vehicles, information about proximate weather (e.g. type and location), and/or information about proximate obstacles. The external systems 112 provide geographic information including geopolitical and terrain data, data about location and type of weather, data about the location and travel routes of other vehicles, and/or data about the location of obstacles. Travel route is the route of travel of the vehicle 102a from its origin, or present location, to its destination.

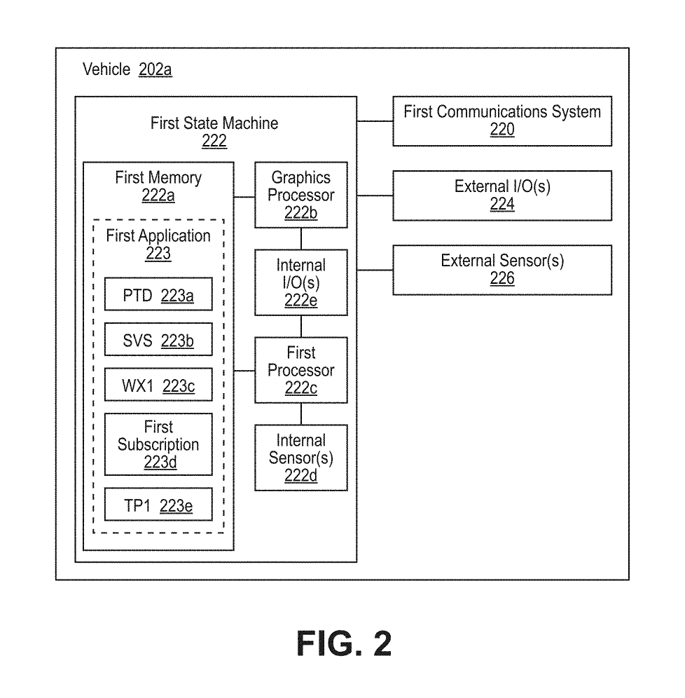

FIG. 2 illustrates a block diagram of one embodiment of the first vehicle (vehicle) 202a configured to display an output of a virtual vehicle system. The illustrated first vehicle 202a comprises a first state machine 222 coupled to a first communications system 220. Optionally, in another embodiment, the first state machine 222 is coupled to at least one external sensor (external sensor(s)) 226 and/or at least one external I/O device (external I/O(s)) 224. I/O means input/output.

The first communications system 220 facilitates direct or indirect communications with satellite(s) 106, ground stations(s) 110, and/or the operations center 108. Information between the first vehicle 202a and the operations center 108 is communicated through the first communications system 220.

The first state machine 222 is a portable computer, such as a phablet, a tablet, a convertible-hybrid laptop, or a detachable-hybrid tablet. The convertible-hybrid laptop and the detachable hybrid tablet have a physical keyboard. The portable computer is separate from any computer permanently installed in the first vehicle 202a. A computer permanently installed in the first vehicle 202a is also referred to as an on-platform computer.

In one embodiment, the display of such a first state machine 222 can be mounted, e.g. in the cockpit, so that it is readily visible to an operator, e.g. a pilot, of the first vehicle 202a. In another embodiment, the display of the first state machine 222 is a touch or non-touch screen display. The display shows information from, or generated from data from, the operations center 108 for consumption by the operator of the first vehicle 202a. Preferably, the first state machine 222 is mounted with respect to the first vehicle 202a so that its internal sensor(s) 222d, e.g. accelerometers, when in a normal stationary position measure an actual attitude (e.g. pitch, roll, and yaw angles) of the first vehicle 202a. Alternatively, the video output of the first state machine 222, e.g. the output from a graphics processor 222b, can be coupled to a display of the external I/O(s) 224, and/or a heads up display of the external I/O(s) 224 that displays an image on a windscreen of the vehicle 222a.

In one embodiment, the first state machine 222 includes a first memory 222a coupled to a first processor 222c. The first processor 222c may be a central processing unit or a digital signal processor. The memory 222a may be magnetic memory (e.g. a hard drive), optical memory (e.g. a DVD or Blu-Ray player which can read and/or write to an optical disc), and/or semiconductor memory (e.g. random access memory, flash memory, read only memory, etc.). Optionally, in another embodiment, the illustrated embodiment of the first state machine 222 can include the graphics processor 222b, such as a graphics processing unit, e.g. for rendering images on display(s) of the first state machine 222 and/or the external I/O(s) 224; correspondingly, the graphics processor 222B is coupled to such display(s). Alternatively, in a further embodiment, the first processor 222c, the first memory 222a, and/or the graphics processor 222b can be implemented in whole or in part with an application specific integrated circuit and/or a field programmable gate array in addition to or in lieu of a first processor 222c, the first memory 222a, and/or a graphics processor 222b.

In one embodiment, the internal I/O(s) 222e include a touch screen display, button(s), cursor control device(s) (e.g. a touchpad and/or a pointing stick), and/or a physical keyboard. The external I/O(s) 224 include multifunction control display unit(s), touch screen display(s), button(s), cursor control device(s) (e.g. a mouse, a touchpad, a trackball, and/or a pointing stick), and/or a physical keyboard. The internal I/O(s) 222e and/or the external I/O(s) 224 facilitate displaying the output and entering input data respectively of and into the first state machine.

In one embodiment, the external sensor(s) 226 include compass(es), inertial navigation units (e.g. including accelerometer(s) and/or gyroscope(s)), barometric altimeter(s), air data and angle of attack computer, ADS-B/C transponder, radar altimeter and/or weather RADAR or satellite data receiver. The electronic interfaces of the external I/O(s) 224 and/or external sensor(s) 226 may be coupled through the first communications system 220 to the first state machine 222 by wireless means, e.g. by WiFi or Bluetooth, or by wired means, e.g. by a USB or Ethernet cable.

In one embodiment, the internal sensor(s) 222d include cameras(s), microphone(s), accelerometer(s), ambient light sensor(s), gyroscope(s), magnetometer(s), temperature sensor(s), barometer(s), and/or global navigation satellite system (GNSS) receiver(s) such as a GPS receiver(s). The internal sensor(s) 222e generate data about the first vehicle 202a that can be used to determine parameters about the first vehicle 202a. Such parameters about the first vehicle 202a include geographical location (e.g. altitude, latitude and longitude), heading, roll, yaw, pitch, and speed (e.g. horizontal speed and vertical speed) of the vehicle. The generated data and/or the parameters can be communicated by the first state machine 222, via the first communications system 220, to the operations center 108. As will be subsequently described in more detail, the operations center 108 can then use and/or manipulate the communicated data and/or parameters, and/or other data to provide control, environmental, safety, and/or other information to the first vehicle 202a and its operator, e.g. its pilot.

The first communications system 220 comprises one or more transceivers, e.g. HF transceiver(s), VHF transceiver(s), SATCOM transceivers(s), AeroMACS transceiver(s), Wi-Fi transceiver(s), Bluetooth transceiver(s), WiMAX transceiver(s), cellular transceiver(s), USB transceiver(s), HDMI transceivers, and/or any other type of communications transceivers. The transceivers mentioned herein include all necessary components, including antenna(s) as appropriate, to facilitate proper operation.

In one embodiment, illustrated in FIG. 2, the first memory 222a includes a first application, e.g. a software program, 223. The first application 223 includes one or more subsystems: a primary travel display system (PTD) 223a, a synthetic vision system (SVS) 223b, a first weather system (WX1) 223c, a first travel plan system (TP) 223e, and/or a first subscription system 223d; thus, the first application 223 may have all, some, or one of these sub-systems. Further, some or all of these sub-systems can be combined into set(s) of one or more sub-systems. Optionally, in another embodiment, the first application 223 includes one or more databases which can be used to store data; the database(s) may be part of a corresponding sub-system, or may be separate database(s). For example, flight route data and weather data updates may be stored in database(s) in the first weather system 223c, and geographical and terrain data may be stored in database(s) in the synthetic vision system. Database as used herein means database in the conventional sense and/or any other way of storing data, e.g. data files and/or registers.

The graphics processor 222B (when used) renders graphical output, e.g. from a subsequently described first application 223, instead of (or in addition to) the first processor 222c. The first memory 222a and the first processor 222 (when used) respectively store and execute (at least in part) the first application 223.

The vehicle, e.g. an aircraft, includes a primary travel display which includes speed and heading indicators. For example, for aircraft, the primary travel display is known as a primary flight display. The primary flight display includes an attitude indicator, airspeed indicator, an altitude indicator, heading indicator, and/or a vertical speed indicator. The state machine 222 also generates and presents a primary travel display, e.g. on a display of the at least one internal I/O(s) 222e. The presented primary travel display includes substantially the same, and possibly more, information than is shown in the primary travel display integrated into the first vehicle 202a. The primary travel display system 222a receives data measured by one or more internal sensors(s) 222D (e.g. accelerometer(s), gyroscope(s), magnetometer(s), and/or GNSS receiver(s)) and determines travel parameters of the first vehicle 202a such as speed (e.g. horizontal speed and/or vertical speed), attitude, heading, latitude, longitude, and altitude. For example, heading can be derived from information from a magnetometer. Speed (e.g. horizontal speed and/or vertical speed), attitude, latitude, longitude, and/or altitude can be derived from information from the accelerometer(s), gyroscope(s), and/or GNSS receiver(s).

In one embodiment, data from the external sensor(s) 226 can be used in lieu of or in addition to data from the internal sensor(s) 222d. For example, if the data from two or more internal and/or external sensors is used to generate the same parameter(s), then Kalman filter(s) can be used to fuse such data to enhance the accuracy of the generated parameter(s) using data from the two or more sensors. The primary travel display system 222a then renders indicators of such generated parameters, e.g. a pictorial representation of such indicators to be rendered on a display of the internal I/O(s) 222e, i.e. the display of the portable computer. As described above, rendering of the indicators on the display of the internal I/O(s) 222e may be performed by the graphics processor 222b.

The synthetic vision system 223b generates a two-dimensional simulated projection of a three-dimensional environment into which the vehicle is travelling. The projection is to be rendered, e.g. by the graphics processor 222b, on a display of the internal I/O(s) 224. For example, the simulated environment can display terrain, obstacles, geo-political information (e.g. national boundaries), and the location of other vehicle(s) 102b. Optionally, in one embodiment, primary travel display and/or steering directions (as will be later described) are projected over the environmental simulation, e.g. using the synthetic vision system 223b; alternatively, the primary travel display is shown separately from the simulated environment.

In one embodiment, prior to vehicle departure, the synthetic vision system 223b queries, and receives from, the operations center 108 for data about the simulated environment, e.g. substantially time fixed information such as terrain, obstacles, locations of waterways, roads, and towns/cities, and/or geo-political information. During travel, however, the synthetic vision system 223b queries the operations center for, and receives, data about substantially time variable information such as the location of other vehicle(s) 102b and/or geo-political information (e.g. no fly zones). For example, based upon the geographical location of the first vehicle 202a communicated to the operations center 108, the operations center 108 transmits such substantially time variable information, such as the location of other vehicle, proximate to the first vehicle 202a. The operations center 108 also transmits information updates (e.g. about such substantially time fixed information) to the first vehicle 202a should the first vehicle 202a diverge from its travel route. Using the received data, the synthetic vision system 223b generates a two dimensional representation of a three dimensional image of a view from the first vehicle 202a.

The first weather analysis system 223c comprises a system that queries, and receives from, the operations center 108 information about weather proximate to the vehicle 102a and its travel plan and/or from a weather satellite data receiver (that is part of the external sensor(s) 226). For example, based upon the geographical location of the first vehicle 202a communicated to the operations center 108, the operations center 108 transmits weather information that is proximate to the first vehicle 202a.

In one embodiment, using the received data, the first weather analysis system 223c generates a two or three dimensional graphical display of the weather, relative to location of the first vehicle 102a. For example, the graphical display is in the form of a planned position indicator (PPI) or a sector PPI. The projection is to be rendered, e.g. by the graphics processor 222b, on a display of the internal I/O(s) 222e.

Optionally, in one embodiment, an operator, e.g. a pilot, of the first vehicle 202a enters information about the vehicle's travel plan, e.g. flight plan, through the first travel plan system 223e. Such information is entered prior to departure of the vehicle on the corresponding travel route, e.g. flight path. In another embodiment, the first travel plan system 223e queries the operator, e.g. the pilot, of the first vehicle 102a for specific, prospective travel route information. The travel route information includes departure and arrival points, time of departure, estimated time en route, alternate destination (e.g. in case of bad weather), type of travel (e.g. instrument flight rules or visual flight rules), operator and passenger information, and/or information about the first vehicle 102a. The first travel plan system 223e then transmits that this information to the operations center 108. As will be subsequently described, the operations center 108 generates a corresponding travel route, e.g. flight path, which is communicated to the first travel plan system 223e. Alternatively, in a further embodiment, the first travel plan system 223e generates the corresponding travel route. In yet another embodiment, the first travel plan system 223e also determines the position of the first vehicle 102a with respect to the travel route based upon location data received from internal sensor(s) 222d and/or external sensor(s) 226.

In one embodiment, the first state machine 222 renders on a display the travel route of the first vehicle 102a, and the position of the first vehicle 102a on its travel route. Optionally, in another embodiment, the travel route and/or location of other vehicle(s) 102b (e.g. with respect to the travel route) are rendered, e.g. by the graphics processor 222b, over the display of the weather, e.g. using the first weather system 223c or separate system(s) (not shown) in the first application 223. Based upon measured location of the vehicle, the present location of the first vehicle 202a on the travel route is illustrated and the rendered display of the travel route is centered upon the present location.

In one embodiment, the first application 223 includes a first subscription system (first subscription) 233d. The first subscription system 233d may include an identifier of the first vehicle 202a (such as a tail number, and/or owner or operator name) and/or services subscribed to by the owner or operator of the first vehicle 202a. In another embodiment, the identifier may be encrypted. The owner or operator of the operations center 108 may allow specific vehicles to use only certain services, e.g. based upon a subscription fee paid for such services. For example, the primary travel display may be rendered for free, but the rendering of terrain, weather, travel path, navigation instructions, location of other aircraft, ground proximity warnings, and/or collision avoidance warnings may cost extra, e.g. for each of the different types of information. The subscription fee may be periodic such as monthly or annual, or based upon actual use of such services by the first vehicle 202a. In another embodiment, upon transmission of travel plan data, and/or during travel of the first vehicle 202a along a corresponding travel path, the first application 223, e.g. the first subscription system 233d, communicates the identifier and/or subscribed services to the operations center 108 so that the operations center 108 provides only the authorized services.

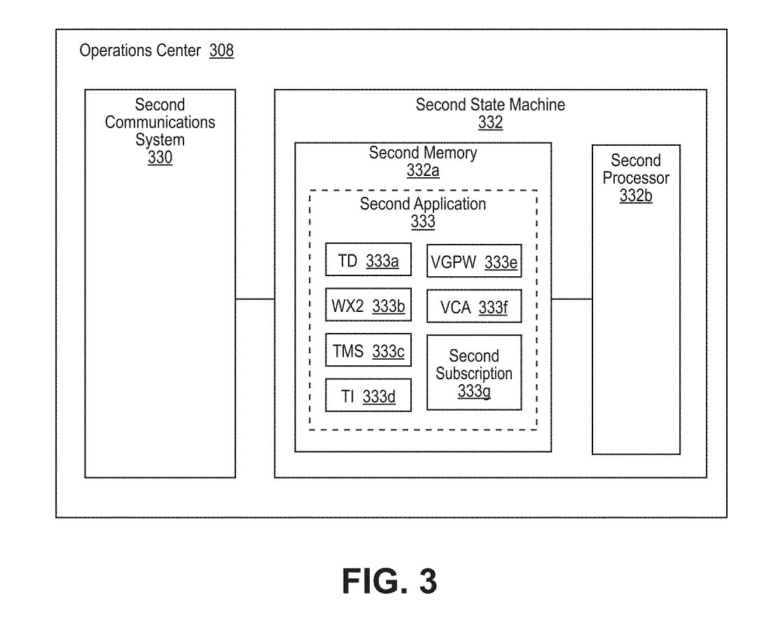

FIG. 3 illustrates a block diagram of one embodiment of an operations center 308. In the illustrated embodiment, the operations center 308 comprises a second state machine 332 coupled to a second communications system 330. The second state machine 332 may also be referred to herein as an off-board computer. The second communications system 330 facilitates direct or indirect communications with the first vehicle 102a, other vehicles 102b, satellite(s) 106, ground stations(s) 110, and/or external system(s) 112. In another embodiment, the operations center 308 may be located at or in a server system or a cloud computing system.

In one embodiment, the second state machine 332 is comprised of a second memory 332a coupled to a second processor 332b. Alternatively, in another embodiment, the second memory 332a, and/or the second processor 332b can be implemented in whole or in part with an application specific integrated circuit and/or a field programmable gate array in addition to or in lieu of the first memory 332a, and/or the second processor 332b.

In one embodiment, illustrated in FIG. 3, the second memory 332a includes a second application, e.g. a software program, 333. The second application 333 includes one or more sub-systems: a travel director system (TD) 333a, a second weather system (WX2) 333b, a travel management system (TMS) 333c, a traffic indication system (TI) 333d, a virtual ground proximity warning system (VGPW) 333e, a virtual collision avoidance system (VCA) 333f, and/or a second subscription system (second subscription) 223g; thus, the second application 332a may have all, some, or one of these sub-systems. Further, some or all of these sub-systems can be combined into set(s) of one or more sub-systems. Optionally, in another embodiment, the second application 332a includes one or more database(s) which can be used to store data, e.g. in the corresponding sub-system, or separate database(s). For example, travel route data, geographical data, and terrain data may be stored in such databases in the travel management system 333c.

The travel director system 333a, e.g. a flight director system, analyzes the trajectory of the first vehicle 102a with respect to its travel path, and generates cues that instruct the operator, e.g. pilot, of the first vehicle 102a to change the direction of the first vehicle 102a so that it maintains on, or returns to, its travel path. Such cues include directions to turn the vehicle, e.g. pitch and bank angles. The cues can be textual and/or graphical commands, projected on a display of the internal I/O(s) 222e and/or verbal commands broadcast by speaker(s) that may be part of the internal I/O(s) 222e, e.g. by a text to voice synthesizer system in the first state machine 222. The cues can also be visual cues such as lines or cross hairs of specific colors which instruct the operator to change the direction of the first vehicle 102a. The cues are communicated by the operations center 208 to vehicles, e.g. who subscribe to this service.

The second weather system (WX2) 333b obtains and stores weather data from other vehicle(s) 102b and other sources of weather such as governmental or private sources such as the US National Weather Service and/or SiriusXM XM WX satellite weather service, aviation weather service, and/or marine weather service. The second weather system 333b may obtain and store data for the regions which its serves, or only for regions proximate to subscriber vehicles, e.g. at the location of the vehicles and further along their travel routes. The weather data, e.g. proximate to the vehicles and further along their flight path, is communicated by the operations center 308 to vehicles, e.g. who subscribe to this service.

The travel management system 333c, e.g. flight management system for an aircraft, generates the travel route, e.g. from the travel plan data, or obtains the travel route from an external system 112 such as the US FAA's SWIM system. For example, the travel route is generated by the travel management system 333c based upon destination location, arrival location, and waypoints provided by the operator of the first vehicle 102a prior to departure, e.g. through the first travel plan system 223e, and known travel ways, stored in the travel management system 333c, through which a vehicle may travel. The travel management system 333c also may determine the position of a first vehicle 102a with respect to the travel route based upon location data received from the first vehicle 102a, and generate travel directions (e.g. heading, attitude, and/or speed), communicated to the first vehicle 102a, to guide the operator and/or vehicle to maintain travel along the travel route. The travel directions also direct the first vehicle 102a back to its travel route should it diverge from its planned travel route. The travel route and travel directions are communicated by the operations center 208 to vehicles, e.g. who subscribe to this service, to be rendered, e.g. over the display of weather.

In one embodiment, the travel management system 333c includes, or uses an external, navigation database that contains elements from which the travel plan is constructed, including waypoints, travel ways (e.g. airways), departure and arrival locations (e.g. airports and their runways), and/or instrument guidance (e.g. standard instrument departure information, standard terminal arrival information, and/or instrument approach procedures). The navigation database may also include map data such as geographical and geopolitical data, e.g. locations of bodies of water, towns, cities, roads, and boundaries. In another embodiment, some or all of this information, to the extent that it is proximate to the first vehicle 102a, is communicated to the first vehicle 102a. The travel route, travel directions, and/or map data is communicated by the operations center 208 to vehicles, e.g. who subscribe to this service. Optionally, in a further embodiment, the first vehicle 102a includes an autopilot and information generated by the travel director system 333a and/or the travel management system 333c are communicated to the autopilot at least when the autopilot is used; as a result, the autopilot ensures that the first vehicle 102a maintains its course on the travel route.

The travel indicator system 333d obtains and stores data about the location (e.g. altitude, latitude, and longitude) of other vehicle(s) 102b from such other vehicle(s) 102b and/or governmental or private sources such as the US FAA's SWIM service. The travel indicator system may obtain and store data for the regions which its serves, or only for regions proximate to subscriber vehicles, e.g. at the location of the first vehicle 102a and further along its travel route. The other vehicle(s) location data, e.g. proximate to the vehicles and further along their flight path, is communicated by the operations center 308 to vehicles, e.g. who subscribe to this service.

The virtual ground proximity warning system 333e obtains altitude information from the first vehicle 102a, e.g. an aircraft, and determines whether the altitude of the first vehicle 102a above the terrain or obstacles (e.g. buildings) over which it travels is and and/or below a first threshold level. The first threshold level may be set by the user, the first application 223, by industry standard, or by law. If the altitude is at and/or below the first threshold level, then the operations center 308 communicates a ground proximity warning to vehicles, e.g. who subscribe to this service, that is displayed and/or announce by an alert sound and/or a synthesized voice by the first state machine 222a. In one embodiment, the ground proximity warning can be displayed over the simulated projection or over the weather projection. In one embodiment, the ground proximity warning received by a vehicle is displayed by the first state machine 222a. For example, the ground proximity warning can be displayed over the simulated projection (e.g. by the synthetic vision system 223b) or over the weather projection (e.g. by the first weather system 223c). Alternatively, such information can be displayed and/or announced through a separate system (not shown).

The virtual collision avoidance system 333f obtains, e.g. from the travel indicator 333d, information about other vehicle(s) proximate to the first vehicle 102a and evaluates if the trajectories of such other vehicle(s) causes them to be within a distance of the first vehicle 102 along its travel route that is less then and/or equal to a second threshold level, then the operations center issues a collision alert to the first vehicle 102a. The collision alert is displayed (and/or announced by an alert sound and/or a synthesized voice) by the first state machine 222a, e.g. by the synthetic vision system 223b. In one embodiment, the collision alert received by a vehicle is displayed by the first state machine 222a. For example, the ground proximity warning can be displayed over the simulated projection (e.g. by the synthetic vision system 223b) or over the weather projection (e.g. by the first weather system 223c). Alternatively, such information can be displayed and/or announced through a separate system (not shown).

The second subscription system 333g maintains evaluates whether a first vehicle 102a is a subscriber to one or more services described above. In one embodiment, the second subscription system 333g includes a database identifying all subscribers and the services to which the subscribers have subscribed. In another embodiment, the second subscription system 333g evaluates the vehicle identifier provided by a vehicle to determine whether it is a subscriber and to which services it has subscribed. Upon making this evaluation and determining that the vehicle is a subscriber, it authorizes the second application 333 to provide the services, and the corresponding data, to the vehicle which has provided its vehicle identifier. For example, the first state machine 222 will cause to be displayed and/or the second state machine 332 will cause to be transmitted to the first vehicle 202a only information to which the subscriber has subscribed. Such information includes without limitation: travel route, directions (e.g. to adhere to travel route), travel direction (e.g. how to turn the vehicle), and information about weather, other vehicles, ground proximity warnings, and/or collision warnings.

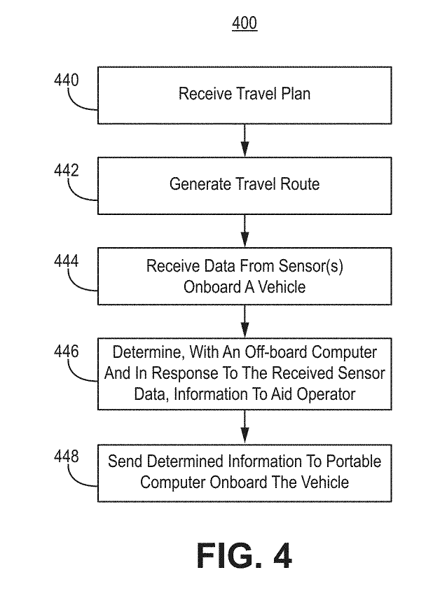

FIG. 4 illustrates one embodiment of a method 400 of operation of an operations center. The embodiment of method 400 shown in FIG. 4 is described here as being implemented in the systems shown in the preceding figures, though it is to be understood that other embodiments can be implemented in other ways. The blocks of the flow diagrams have been arranged in a generally sequential manner for ease of explanation; however, it is to be understood that this arrangement is merely exemplary, and it should be recognized that the processing associated with the methods (and the blocks shown in the Figures) can occur in a different order (for example, where at least some of the processing associated with the blocks is performed in parallel and/or in an event-driven manner).

Optionally, in block 440, receive travel plan data. Optionally, in block 442, generate a travel route of a vehicle (e.g. the first vehicle 102a). In one embodiment, the travel route is generated with the travel plan data by from an off-board computer (e.g. the second state machine 332). Alternatively, the travel route is obtained from another source, e.g. external system(s) 112. In another embodiment, send the travel route to a portable computer (e.g. the first state machine 222) onboard the vehicle, the portable computer being separate from any on-platform computer installed in the vehicle and is configured to render the determined information for consumption by the operator

In block 444, receive, at an off-board computer that is remote from a vehicle, data from at least one sensor (e.g. internal sensor(s) 222d) onboard the vehicle. Optionally, in one embodiment, the received data includes an identifier corresponding to the vehicle, its owner and/or its operator. Optionally, in another embodiment, the received data is encrypted.

In block 446, determine, with the off-board computer in response to the received sensor data, information for aiding an operator of the vehicle in piloting the vehicle. In one embodiment, the information includes:
a. the vehicle's position with respect to the travel route
b. travel directions;
c. cues that instruct the operator of the vehicle to change the direction of the vehicle;
d. weather data proximate to the vehicle and/or the vehicle's future travel route;
e. other vehicle(s) locations;
f. a ground proximity warning; and/or
g. a collision alert.
   The vehicle's future travel route means the portion of the current travel route that the vehicle has yet to travel along. In another embodiment, determining and/or sending the information only if the received identifier is determined to correspond with a subscriber, e.g. a paid-up subscriber.

In block 448, send the determined information to the portable computer onboard the vehicle, the portable computer being separate from any on-platform computer installed in the vehicle and being configured to render the determined information, e.g. indicators representing the received information, for consumption by the operator. An on-platform computer as used herein is a computer installed in a vehicle which is not removable other than for servicing. In one embodiment, the determined information is encrypted.

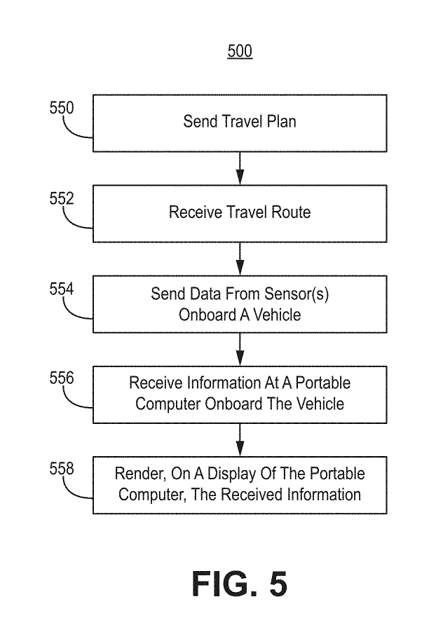

FIG. 5 illustrates an exemplary method 500 of operation of a virtual vehicle system. The embodiment of method 500 shown in FIG. 5 is described here as being implemented in the systems shown in the preceding figures, though it is to be understood that other embodiments can be implemented in other ways. The blocks of the flow diagrams have been arranged in a generally sequential manner for ease of explanation; however, it is to be understood that this arrangement is merely exemplary, and it should be recognized that the processing associated with the methods (and the blocks shown in the Figures) can occur in a different order (for example, where at least some of the processing associated with the blocks is performed in parallel and/or in an event-driven manner).

Optionally, in block 550, sending, from a portable computer, a travel plan data to an off-board computer, the portable computer being separate from any on-platform computer installed in the vehicle. Optionally, in block 552, receiving, from the off-board computer, a travel route at the portable computer for consumption by the operator.

In block 554, send, to an off-board computer, from a portable computer onboard a vehicle, data from at least one sensor onboard the vehicle. Optionally, in one embodiment, send an identifier corresponding to at least one of the vehicle, the vehicle's owner, and the vehicle's operator. In one embodiment, the sending data comprises sending encrypted data.

In block 556, receive information, determined with an off-board computer in response to the sensor data, at a portable computer onboard the vehicle. In one embodiment, the information is received if the sent identifier corresponds to a subscriber of services performed by the off-board computer. In another embodiment, receiving information comprises receiving encrypted information. In a further embodiment, the received information includes:
a. the vehicle's position with respect to the travel route
b. travel directions;
c. cues that instruct the operator of the vehicle to change the direction of the vehicle;
d. weather data proximate to the vehicle and/or the vehicle's future travel route;
e. other vehicle(s) locations;
f. a ground proximity warning; and/or
g. a collision alert.

In block 558, render, on a display of the portable computer, the received information, e.g. indicators representing the received information, for consumption by the operator of the vehicle and to aid the operator in piloting the vehicle.

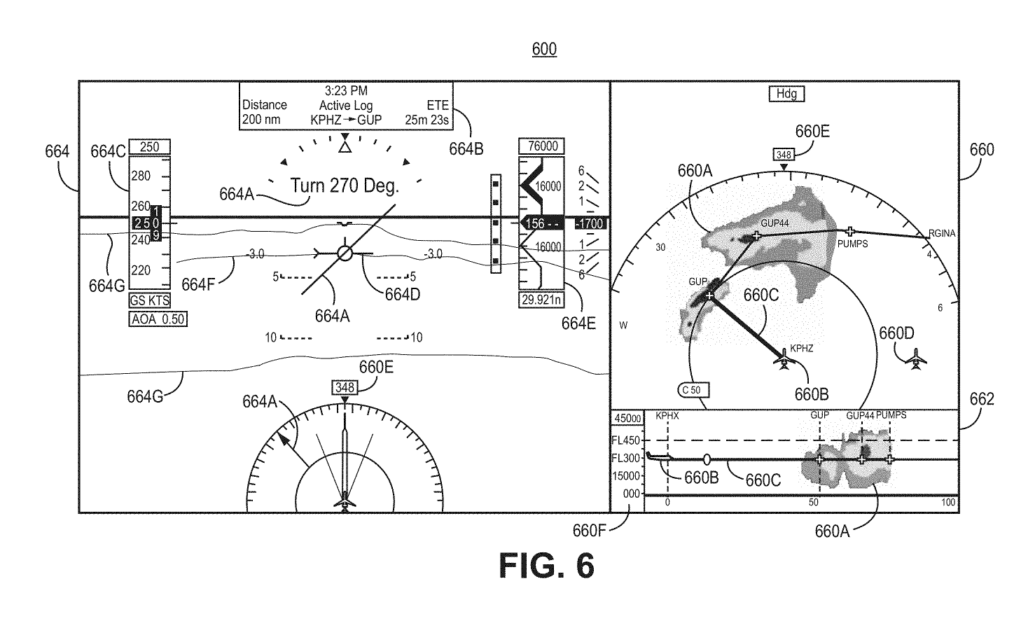

FIG. 6 illustrates one embodiment of a rendered image 600 on a display of a portable computer. On the right hand side of the rendered image 600, a sector PPI display 660 is illustrated. On the left hand side of the rendered image 600, a two-dimensional simulated projection 664 of a three-dimensional environment ahead of the vehicle is illustrated.

In one embodiment, the sector PPI display 660 illustrates weather 660A proximate to the vehicle, a location 660B of a vehicle, and/or a travel route 660C (e.g. including waypoints GUP, GUP44, and PUMPS) of the vehicle. Optionally, the sector PPI display 660 displays compass heading 660E.

Optionally, the rendered image 600 includes an E-scope display 662, e.g. illustrating the height 660F and location 660B of the vehicle, the travel route 660C (e.g. including waypoints GUP, GUP44, and PUMPS) of the vehicle, and weather 660A proximate to the vehicle. In another embodiment, the E-scope display 662 is proximate to, e.g. under, the sector PPI display 660.

The two-dimensional simulated projection 664 displays simulated terrain 664G. In one embodiment, the two-dimensional simulated projection 664 displays components of a primary flight display, e.g. an altimeter 664E, a speedometer 664C, an attitude indicator 664D, and a heading indicator 660E. Optionally, the two-dimensional simulated projection 664 displays cues 664A and/or travel directions 664B.

### Example Embodiments

Example 1 includes a method, comprising: receiving, at an off-board computer that is remote from a vehicle, data from at least one sensor onboard the vehicle; determining, with the off-board computer in response to the received sensor data, information for aiding an operator of the vehicle in piloting the vehicle; and sending the determined information to a portable computer onboard the vehicle, the portable computer being separate from any on-platform computer installed in the vehicle and being configured to render the determined information for consumption by the operator.

Example 2 includes the method of Example 1, wherein the received data further comprises an identifier corresponding to at least one of the vehicle, the vehicle's owner, and the vehicle's operator.

Example 3 includes the method of Example 2, wherein at least one of (a) determining and (b) sending the information is only performed if the received identifier is determined to correspond to a subscriber.

Example 4 includes the method of any of Examples 1-3, wherein receiving data comprises receiving encrypted data.

Example 5 includes the method of any of Examples 2-4, wherein sending the determined information comprises sending determined information that is encrypted.

Example 6 includes the method of any of Examples 1-5, wherein sending the determined information comprises sending the determined information comprising at least one of: the vehicle's position with respect to the travel route, at least one travel direction, at least one cue that instructs the operator of the vehicle to change the direction of the vehicle, weather data proximate to at least one of the vehicle and the vehicle's future travel route, a location of at least one other vehicle, a ground proximity warning, and a collision alert.

Example 7 includes the method of any of Examples 1-6, further comprising receiving, at the off-board computer, travel plan data from a portable computer onboard the vehicle.

Example 8 includes the method of any of Examples 1-7, further comprising: generating a travel route; and sending the travel route to the portable computer which is configured to render the travel route for consumption by the operator.

Example 9 includes a method, comprising: sending, to an off-board computer, from a portable computer onboard a vehicle, data from at least one sensor onboard the vehicle; receiving information, determined with the off-board computer in response to the sensor data, with a portable computer onboard the vehicle, the portable computer being separate from any on-platform computer installed in the vehicle; and rendering, on a display of the portable computer, the received information for consumption by the operator of the vehicle and to aid the operator in piloting the vehicle.

Example 10 includes the method of Example 9, further comprising sending an identifier corresponding to at least one of the vehicle, the vehicle's owner, and the vehicle's operator.

Example 11 includes the method of Example 10, wherein the information is received only if the sent identifier corresponds to a subscriber of services performed by the off-board computer.

Example 12 includes the method of any of Examples 9-11, wherein sending the data comprises sending encrypted data.

Example 13 includes the method of any of Examples 9-12, wherein receiving information comprises receiving encrypted information.

Example 14 includes the method of any of Examples 9-13, wherein the receiving the information comprises receiving information comprising at least one of: the vehicle's position with respect to the travel route, at least one travel direction, at least one cue that instructs the operator of the vehicle to change the direction of the vehicle, weather data proximate to at least one of the vehicle and the vehicle's future travel route, a location of at least one other vehicle, a ground proximity warning, and a collision alert.

Example 15 includes the method of any of Examples 9-14, further comprising sending travel plan data from a portable computer onboard the vehicle to an off-board computer.

Example 16 includes the method of any of Examples 9-15, further comprising receiving, from the off-board computer, a travel route at the portable computer for consumption by the operator.

Example 17 includes a vehicle, comprising: a communications system; a portable computer coupled to the communications system; and wherein the portable computer comprises: a processor; a memory coupled to the processor; at least one input/output device; wherein the at least one input/output device comprises a display; at least one sensor; and wherein the portable computer is configured to: send data from at least one sensor through the communications system to an off-board computer; receive information, determined with the off-board computer, in response to the sensor data; and render, on the display, the received information for consumption by an operator of the vehicle to aid the operator in piloting the vehicle.

Example 18 includes the vehicle of Example 17, wherein receive the information comprises receive information comprising at least one of: a position of the vehicle with respect to the travel route, at least one travel direction, at least one cue that instructs the operator of the vehicle to change the direction of the vehicle, weather data proximate to at least one of the vehicle and the vehicle's future travel route, a location of at least one other vehicle, a ground proximity warning, and a collision alert.

Example 19 includes the vehicle of any of Examples 17-18, wherein the at least one sensors comprise at least one of an accelerometer, a gyroscope, a magnetometer, and a GNSS receiver.

Example 20 includes the vehicle of any of Examples 17-19, wherein the portable computer includes a subscription identifier.

Although specific embodiments have been illustrated and described herein, it will be appreciated by those of ordinary skill in the art that any arrangement, which is calculated to achieve the same purpose, may be substituted for the specific embodiments shown. Therefore, it is manifestly intended that this invention be limited only by the claims and the equivalents thereof.

Although specific embodiments have been illustrated and described herein, it will be appreciated by those of ordinary skill in the art that any arrangement, which is calculated to achieve the same purpose, may be substituted for the specific embodiments shown. Therefore, it is manifestly intended that this invention be limited only by the claims and the equivalents thereof.

What is claimed is:

1. A method, comprising:
receiving, at an off-board computer that is remote from a vehicle, data from at least one sensor onboard the vehicle;
determining, with the off-board computer in response to the received sensor data, information for aiding an operator of the vehicle in piloting the vehicle; and
sending the determined information to a portable computer onboard the vehicle, the portable computer being separate from any on-platform computer installed in the vehicle and being configured to render the determined information for consumption by the operator.

2. The method of claim 1, wherein the received data further comprises an identifier corresponding to at least one of the vehicle, the vehicle's owner, and the vehicle's operator.

3. The method of claim 2, wherein at least one of (a) determining and (b) sending the information is only performed if the received identifier is determined to correspond to a subscriber.

4. The method of claim 1, wherein receiving data comprises receiving encrypted data.

5. The method of claim 2, wherein sending the determined information comprises sending determined information that is encrypted.

6. The method of claim 1, wherein sending the determined information comprises sending the determined information comprising at least one of: the vehicle's position with respect to the travel route, at least one travel direction, at least one cue that instructs the operator of the vehicle to change the direction of the vehicle, weather data proximate to at least one of the vehicle and the vehicle's future travel route, a location of at least one other vehicle, a ground proximity warning, and a collision alert.

7. The method of claim 1, further comprising receiving, at the off-board computer, travel plan data from a portable computer onboard the vehicle.

8. The method of claim 1, further comprising:
generating a travel route; and
sending the travel route to the portable computer which is configured to render the travel route for consumption by the operator.

9. A method, comprising:
sending, to an off-board computer, from a portable computer onboard a vehicle, data from at least one sensor onboard the vehicle;
receiving information, determined with the off-board computer in response to the sensor data, with a portable computer onboard the vehicle, the portable computer being separate from any on-platform computer installed in the vehicle; and
rendering, on a display of the portable computer, the received information for consumption by the operator of the vehicle and to aid the operator in piloting the vehicle.

10. The method of claim 9, further comprising sending an identifier corresponding to at least one of the vehicle, the vehicle's owner, and the vehicle's operator.

11. The method of claim 10, wherein the information is received only if the sent identifier corresponds to a subscriber of services performed by the off-board computer.

12. The method of claim 9, wherein sending the data comprises sending encrypted data.

13. The method of claim 9, wherein receiving information comprises receiving encrypted information.

14. The method of claim 9, wherein the receiving the information comprises receiving information comprising at least one of: the vehicle's position with respect to the travel route, at least one travel direction, at least one cue that instructs the operator of the vehicle to change the direction of the vehicle, weather data proximate to at least one of the vehicle and the vehicle's future travel route, a location of at least one other vehicle, a ground proximity warning, and a collision alert.

15. The method of claim 9, further comprising sending travel plan data from a portable computer onboard the vehicle to an off-board computer.

16. The method of claim 9, further comprising receiving, from the off-board computer, a travel route at the portable computer for consumption by the operator.

17. A vehicle, comprising:
a communications system;
a portable computer coupled to the communications system; and
wherein the portable computer comprises:
a processor;
a memory coupled to the processor;
at least one input/output device;
wherein the at least one input/output device comprises a display;
at least one sensor; and
wherein the portable computer is configured to:
send data from at least one sensor through the communications system to an off-board computer;
receive information, determined with the off-board computer, in response to the sensor data; and
render, on the display, the received information for consumption by an operator of the vehicle to aid the operator in piloting the vehicle.

18. The vehicle of claim 17, wherein receive the information comprises receive information comprising at least one of: a position of the vehicle with respect to the travel route, at least one travel direction, at least one cue that instructs the operator of the vehicle to change the direction of the vehicle, weather data proximate to at least one of the vehicle and the vehicle's future travel route, a location of at least one other vehicle, a ground proximity warning, and a collision alert.

19. The vehicle of claim 17, wherein the at least one sensors comprise at least one of an accelerometer, a gyroscope, a magnetometer, and a GNSS receiver.

20. The vehicle of claim 17, wherein the portable computer includes a subscription identifier.
